(19) United States
(12) Patent Application Publication
(10) Pub. No.: US 2012/0081794 A1
(43) Pub. Date: Apr. 5, 2012

(54) Insulating Corrective Lens Insert for Windows

(76) Inventor: Robert James SHOWERS, Naugatuck, CT (US)

(21) Appl. No.: 13/081,928

(22) Filed: Apr. 7, 2011

Related U.S. Application Data
(60) Provisional application No. 61/390,065, filed on Oct. 5, 2010.
(60) Provisional application No. 61/393,086, filed on Oct. 14, 2010.
(60) Provisional application No. 61/407,328, filed on Oct. 27, 2010.
(60) Provisional application No. 61/447,747, filed on Mar. 1, 2011.

(51) Int. Cl. G02B 27/00

(52) U.S. Cl. 359/613; 359/893

(57) ABSTRACT

A insulated insert for window systems that provide additional insulating properties by means of insulating gel technologies. The present invention comprises of view through components that provide users with areas to view through the window. The present invention also comprises of thermal break adapters in between connections of different components to ensure maximum insulation and prevents direct conduction.

The current application claims a priority to the U.S. Provisional Patent application Ser. No. 61/390,065 filed on Oct. 5, 2010, the U.S. Provisional Patent application Ser. No. 61/393,086 filed on Oct. 14, 2010, the U.S. Provisional Patent application Ser. No. 61/407,328 filed on Oct. 27, 2010, and the Provisional Patent Application Ser. No. 61/447,747 filed on Mar. 1, 2011.

### FIELD OF THE INVENTION

The invention relates generally to a window system that is able to effectively insulate heat. It is the objective of the present invention to insulate heat as well as allow the user to be able to see through the window while adjusting what direction the viewer can see in.

### BRIEF DESCRIPTION OF THE PRIOR ART

With limited natural resources, energy providers are beginning to charge real estate owners more for their services. To compensate for the increase in energy prices, energy efficient products are constantly being developed. Even methods of constructing homes and buildings are changing to become more energy efficient. A direction for contractors to make buildings more energy efficient is to include energy efficient windows. There have been many windows developed that minimize heat transfer by increasing the insulation. Among these windows are insulated glazing units, which include two or more panes of glass separated by a spacer frame. Within the frame and panes of glass is sealed an insulating gas which increases the R-value and U-factor of the window. This allows for increased insulation and is moderately energy efficient. When finishing these insulated glazing units, developers have often tried to increase the insulating properties by using different materials for sealants, spacers or even adding coatings to the glazing. However, replacing different materials for the insulated glazing units only had mediocre effects on the insulating properties of the window. To make a significant increase in insulating properties, rather than the use of gasses to fill the insulating glazing units, aerogel particles was used.

The U.S. Pat. No. 4,831,799 introduces a multi-layered insulated glazing unit that can be filled with insulating gasses. This type of insulating glazing unit does not make use of the compound aerogel.

The U.S. Pat. No. 7,641,954 introduces a panel and glazing system that makes use of non-optimizable thermoplastic panels that is not adjustable with continuous internal channels that are able to hold aerogel compound. The insulated glazing system proposed in this patent makes use of two U-shaped elements to create spacing to bind the thermoplastic panels for insulation. The insulated glazing system instead of using two flat glass panes with spacers and sealants makes use of U-shaped glass elements to seal the insulating panel. This invention is a non-optimizable continuous vessel system that is non-adjustable.

The United States Patent H975 introduces a non-optimizable, non-adjustable continuous thermal insulated glazing unit that makes use of aerogel particles to fill the thermal gaps within the glazing unit. However, aerogel is only translucent and not transparent, leaving the user unable to see through.

The United States Patent Application Publication 2007/0122588 A1 introduces a non-optimizable, non-adjustable glazing unit with a continuous honeycombed structure to contain silica aerogel particles. However, again the aerogel is used to fill all the compartments and reduces the ability of a user to see through.

The U.S. Pat. No. 4,950,344 introduces a method of manufacturing a multiple-glass-pane glazing unit having a thermo-set structural silicone foam spacer serving as a thermal break. The structural foam spacer is located at the peripherally of the glass panes only. The structural foam spacer is not bound by the glazing's actual design by itself The structural foam spacer is bonded only by adhesives. This method bonds poorly when glazing of glass is replaced by polycarbonate glazing. This invention is only bonded effectively at the periphery of panes made of glass, whereas later in the manufacturing process a necessary supporting window frame typically made of wood, vinyl, metal or fiberglass may be utilized to further insure necessary structural integrity of the thermal breaking structural foam spacer. Polycarbonate is far more flexible than glass when faced with wind load and is harder to bond to. This invention therefore does not include interlocking structural foam serving as a thermal break spacer that is bound in anyway by the glazing's actual design in itself.

A commercial product which involves the enclosure of aerogel in polycarbonate vessels is used as day-lighting windows. These daylighting windows do not allow users to clearly see through the windows. None of the prior art stated above with aerogel allow a user to see through and does not allow a user to have control over what direction they can see through the window system.

The following technical features of the present invention will be appreciated by those of skill in the art. The invention is a optimizeable view through gel enhanced IGU lenses system, a insulating lenses system insert that transmits and/or refracts light that can be used for the optimization of these multiple benefits: Provides engineers the benefit of manipulating, therefore optimizing, performance in regard to heat transfer, soundproofing, light diffusion, light penetration, light density, ultraviolet (UV) light filtration, light distribution, light glare, security, privacy, solar rays, user viewing direction, and range that windows can be viewed into and out through based on their specifications. The geometric glazing optimization possibilities of the present invention far exceed all other prior art. The vessels can be manufactured to any shape or design within the parameters of the IGU cavity. In addition, the at least one cavities inside the vessel inserts can be mold injected into any shape to have square, trapezoid, polygon, honeycombed or other patterns. Existing art is typically extruded and only provides vessels with limited geometric possibilities where the walls are continuous following a single direction. The mold injection method offers the vessel to be manufactured with intersecting walls of different shapes for far more geometric benefits and effects. View through areas can be hollow meaning a hole clear through, 100% solid transparent polycarbonate, 100% transparent polycarbonate with indentations, or a hole clear through with a inserted glazing layer that sets in a thermal break. If integrated transparent polycarbonate or inserted transparent glazing is in the view through areas it serves as an IGU cavity dividing layer. This view through area may be fully integrated polycarbonate, or glazing layer inserted into a thermal break, serving to divide the air or gas space in a IGU cavity. This dividing layer in view through significantly reduces energy transfer that would otherwise exist due to convection. Convection is well established as the transmission of heat through air or gas by the circulation of currents; the vertical movement of heat especially by updrafts and downdrafts in a cavity between the two layers of glazing making up an IGU. A thermal break is added as an innovative separate component used in the notch that separates the polycarbonate vessel from the inserted view through glazing layer. Without this thermal break between the gel insulated part of the vessel and the vessels view through area dividing layer direct conduction would reduce the inventions ability to further minimize heat transfer. The thermal break serves to further reduce heat transfer and increase overall thermal performance. Thermal breaks are used throughout the invention that are constructed of a less conductive material such as structural foam or other suitable low conductive material, or other suitable technologies that may in the future be made available. Additionally, the polycarbonate vessel serving as a IGU insert can be manufactured to have a plurality of holes distributed throughout its surface leading into the cavities. The plurality of holes is sealed using vessel films to ensure the insulating gels are securely held inside the plurality of cavities while reducing heat circulation for reduced heat transfer. The plurality of holes serves to reduce the amount of polycarbonate used for the vessel and also reduce the surface area that can be contacted by other materials. The holes reduced surface area therefore directly translates to less direct conduction of heat transfer that can travel through the otherwise continuous solid polycarbonate vessel. The holes though interior dividing walls are also laminated to limit convection. Existing prior art is not thermally broken in the transparent glazing itself only the frames that mount glazing at times are is. The invention can also be more easily side loaded with a gel insulating substance unlike the prior art that is loaded through edges only. These technical features of the invention allow for choosing the best element from said set of alternative glazing benefits for maximizing overall function by systematically choosing the values of necessary variables that are currently and collectively unavailable in the glazing industry. The invention allows optimization techniques for finding the best available values of glazing's objective function, including a variety of different types of objective functions.

### BACKGROUND OF THE INVENTION

Recently, the thermal insulating properties of Aerogel have been uncovered. Aerogel was discovered in 1931 by Samuel Stephen Kistler. Since then, aerogel has constantly been researched and improved upon. Aerogels have now been applied to the window industry to product highly energy efficient windows. In the place of gases for the insulated glazing unit, Aerogels have been sealed within the window. However, even though Aerogel is translucent, it is not transparent. This property of Aerogel prevents the user from being able to see through a window long-term as clearly if it was glazing made of glass. Aerogel has also been applied to polycarbonate vessels for day-lighting windows. However, this application of aerogel has still yet to allow users to see through the windows.

New wall constructions are required by USA building codes to be up to R-19 value and ceilings are required to be up to R-42. R-values are a measure of thermal resistance used in building and construction. Traditional double pane windows with high visible glass currently on the market, on average, only have an R-value of 3. The present invention will be a gel insulated glazing unit that will be highly insulating while adding value though additional options such as geometric view through design possibilities over traditional windows offered on the market today.

The present invention is an insulated glazing unit which utilizes Aerogel particles sealed in a vessel as well as insulating gases to minimize the transfer of heat across a IGU window system. The aerogel filled vessel can be arranged in different patterns within a IGU cavity. Aerogel is a translucent material but not transparent, therefore the present invention contains the aerogel in a vessel to be arranged in a way where users can still look through a window while giving the window an aesthetically pleasing appearance. In addition, the vessel can be customized to control the direction the viewers from inside and outside can see through the window system. The ability of the present invention to control the range and direction of vision collectively makes a corrective lens insert for the IGU window system. The aerogel also has exceptional insulating properties which will aid the present invention to minimize heat transfer across the window. The invention, an optimizable view through gel enhanced IGU lenses system, is a insulating lenses system which allows light to traverses through and/or refract can be used for the optimization of these multiple following benefits: provides engineers the benefit of optimally manipulating the performance of the IGU window system in regards to not only heat transfer, but also soundproofing, light diffusion, light penetration, light density, ultraviolet (UV) light filtration, light distribution, light glare, security, privacy, solar rays, user viewing direction, and range that windows can be viewed into and out through. This view through areas can be 100% solid transparent polycarbonate, 100% transparent polycarbonate with indentations or holes clear through having sidewalls. Fully integrated polycarbonate view through areas having indentations or inserted glazing in view through areas serves as an IGU cavity dividing layer. The view through areas having a fully integrated polycarbonate layer serves to divide, or transparent glazing layer inserted into a thermal break, the air or gas space in a IGU cavity. This dividing glazing layer provides a view though areas while reducing energy transfer that would otherwise exist due to convection. Convection is well established as the transmission of heat in air or gas by the circulation of currents. This is especially true for vertical movement of heat by updrafts and downdrafts within the cavity between the two layers of glazing making up an IGU. The thermal break is a separate component used in the notch that separates the polycarbonate gel insulated vessel area from the inserted view through glazing layer. Without the thermal break, direct conduction would undermine the inventions ability to even further minimize heat transfer. The thermal break serves to reduce heat transfer through conduction and increase overall thermal performance. The thermal break is constructed of a less-conductive material such as structural foam or other suitable low conductive material, or other suitable technologies that may in the future be made available. In addition to the thermal break, the vessel may be manufactured to have a plurality of holes. The plurality of holes is sealed using vessel films to keep the gel insulating element secure within the plurality of cavities. Interior partitions also have holes and are laminated to limit air flow through these thermal breaking holes. The plurality of holes serves to reduce the amount of polycarbonate used for the vessel and also reduce the surface area that can be contacted by other materials. The reduced surface area directly translates to less direct conduction of heat transfer that can travel through the polycarbonate vessel.

### BRIEF DESCRIPTION OF THE DRAWINGS

FIG. 1 is a perspective view of the preferred embodiment of the present invention, where the view through components is fully integrated with the vessel base.

FIG. 2 is an exploded view of the preferred embodiment of the present invention.

FIG. 3 is a top plan view of the preferred embodiment in which a sectional view is taken and shown in FIG. 4.

FIG. 4 is a front elevational view of the preferred embodiment showing the cross section of the present invention in which detailed views are taken and shown in FIG. 5-9.

FIG. 5 is a detailed sectional view of the solid view through component.

FIG. 6 is a detailed sectional view of the hollow view through component with a dividing layer.

FIG. 7 is a detailed sectional view of an indented view through component.

FIG. 8 is a detailed sectional view of the hollow view through component without a dividing layer.

FIG. 9 is a detailed sectional view of a thermal break partition connecting the vessel cover and the vessel base.

FIG. 10 is an exploded view of another embodiment of the present invention, where the view through components are not fully integrated with the vessel base.

FIG. 11 is a top plan view of the embodiment of the present invention where the view through components are a separate component showing a plane in which a sectional view is taken and shown in FIG. 12.

FIG. 12 is a front elevational view of the embodiment of the present invention where the view through components are a separate component in which detailed views are taken and shown in FIG. 13-16.

FIG. 13 is a detailed sectional view of the solid view through component that is not fully integrated, but engaged to the vessel base and the vessel cover.

FIG. 14 is a detailed sectional view of the hollow view through component with a dividing layer that is not fully integrated with the vessel base, but is engaged to the vessel base and the vessel cover.

FIG. 15 is a detailed sectional view of the indented view through component that is not fully integrated with the vessel base, but is engaged to the vessel base and the vessel cover.

FIG. 16 is a detailed sectional view of the hollow view through component without the dividing layer that is not fully integrated with the vessel base, but is engaged to the vessel base and the vessel cover.

FIG. 17 is an exploded view of another embodiment of the present invention where the plurality of end openings and the plurality of cavities are sealed by a plurality of end caps.

FIG. 18 is a front elevational view of another embodiment of the present invention where the vessel base and the vessel cover are not connected by a thermal break partition, but instead, the vessel base comprises of a fully integrated partition that allows the vessel cover to be engaged and secure. The diagram is showing a detailed view that is taken and shown in FIG. 19.

FIG. 19 is a detailed front elevational view of a partition showing the notch groove and the thermal break component.

FIG. 20 is a detailed perspective view of the present invention showing the interior vessel film, film adhesives, plurality of cover holes, and the plurality of base holes.

### DETAIL DESCRIPTIONS OF THE INVENTION

All illustrations of the drawings are for the purpose of describing selected versions of the present invention and are not intended to limit the scope of the present invention. Although suitable materials are specified for the invention all other suitable materials, to include emerging technologies that may be made commercially available in the future, may also be used.

Thermal insulating windows have become a product that is able to help families, buildings, subways, cruise ships and other conditioned living spaces significantly save on energy costs. Many types of windows have been developed trying to maximize insulation and minimize heat transfer. The present invention is an Insulating Glass Unit (IGU) vessel that serves as the IGU cavity insert. The invention utilizes a highly versatile IGU cavity insert that is nanotechnology gel insulation enhanced, UV stable transparent polycarbonate vessel. The IGU insert has view through areas that may be one or more of the following; 100% solid polycarbonate, 100% polycarbonate with indentations, a hole having walls through the vessel insert, a hole having walls through the insulating insert with a inserted layer of glazing. All of these areas that are not obscured by the insulating gel are for viewing through. It is the objective of the present invention to be optimized in regard to insulating, soundproofing, light diffusion, light penetration, light density, ultraviolet (UV) light filtration, light distribution, light glare, security, privacy, solar rays, user viewing direction, and range that windows can be viewed into and out through.

The invention, an optimizable view through gel enhanced IGU lenses system, is a insulating lenses system IGU cavity insert which allows light to traverses through and/or refract can be used for the optimization of these multiple following benefits: provides engineers the benefit of optimally manipulating the performance of the window system in regards to not only heat transfer, but also soundproofing, light diffusion, light penetration, light density, ultraviolet (UV) light filtration, light distribution, light glare, security, privacy, solar rays, user viewing direction, and range that windows can be viewed into and out through. Fully integrated polycarbonate or inserted glazing in view through areas serves as a dividing layer 223. The view through areas having a fully integrated polycarbonate layer serves to divide, or glazing layer inserted into a thermal break, the air or gas space in a IGU cavity. This dividing glazing layer provides a view though area significantly reducing energy transfer that would otherwise exist due to convection. Convection is well established as the transmission of heat in air or gas by the circulation of currents. This is especially true for vertical movement of heat by updrafts and downdrafts within the cavity between the two layers of glazing making up an IGU. The thermal break is a separate component used in the notch that separates the polycarbonate insulating insert from the inserted view through glazing layer. Without the thermal break, direct conduction would undermine the inventions ability to even further minimize heat transfer. The thermal break serves to further reduce heat transfer and increase overall thermal performance. The thermal break is constructed of a less-conductive material such as structural foam or other suitable low conductive material, or other suitable technologies that may in the future be made available. This same type of structural foam is commonly used, although utilized much differently, in different configurations and different purpose as an Insulated Glass unit perimeter edge spacer. The structural foam is also commercially available from Edgetech and Dow Corning. Dow adhesive designed specifically for the structural foam shall be applied to the silicone structural foam in order to effectively bond the film having the highly reflective mirror like surface. The mirror like surface shall serve to reflect the image of the polycarbonate and, or suitable gel insulating substance for esthetic purposes and, or, reflect radiant heat. The structural foam thermal break serving as a spacer is preferably a thermoset silicone foam matrix. The thermoset polymer thermal break serving as the spacer is set to size and shape during heat curing while factoring in the film thickness as a final laminate in order to precision fit the contour of the receiving contour in the polycarbonate receiver. The thermal breaking spacer retains its flexibility and possesses a low compression set. The structural foam is bonded in place with a suitable high-performance acrylic adhesive. Silicone thermal breaking spacers used in the fenestration industry are known to resist heat flow up over 900 times more than aluminum. The insulating insert may be manufactured to have a plurality of holes. The plurality of holes is sealed using transparent vessel adhesive and vessel films to keep the gel insulating element 6 secure within the plurality of cavities 4. The plurality of holes serves to reduce the amount of polycarbonate used for the insulating insert and also reduce the surface area that can be contacted by other materials. The reduced surface area directly translates to less direct conduction of heat transfer that can travel through the polycarbonate insulating insert. The present invention is a type of window system insert that makes use of insulating materials with exceptional insulating properties to minimize heat transfer across the window. This invention is able to effectively insulate and reduce heat transfer while allowing users to be able to see through the window without being hindered by the insulating material. The insert is a two part insert that comprises of a vessel cover 1 and a vessel base 2. In addition to the vessel base 2 and the vessel cover 1 the present invention comprises of a plurality of cavities 4, a plurality of end openings 5, an insulating element 6, a vessel coating 7, an interior vessel film 8, a film adhesive 9, an end opening sealing film 10, and a sealing adhesive 20. The vessel cover 1 and the vessel base 2 together form the main body of the present invention. In the preferred embodiment of the present invention, these polycarbonates are to be transparent and manufactured from Lexan polycarbonate. Other suitable transparent polycarbonates such as Calibre from Dow Chemicals Company, Iupilon from Mitsubishi Engineering Plastic Corporations, Makrolife from Arla Plast, Makrolon from Bayer Material Science Group, Panlite from Teijin Chemical Limited, Tarflon from Idemitsu Kosan Co., and LBE from Rodeca may also be used. No matter what material is used, it is important that the material be clear enough as to allow the desired amount of natural light through the window. The polycarbonate materials of the vessel base 2 and the vessel base 2 is covered with the vessel coating 7 or can be manufactured to be UV stabilized and UV deflective, preventing it from being damaged from UV rays and allowing it to reflect the destructive UV rays from its direction of origin. Being UV stabilized also prevents the material from yellowing. The vessel coating 7 provides the vessel base 2 and the vessel cover 1 with the property of being UV stable for long lasting clarity.

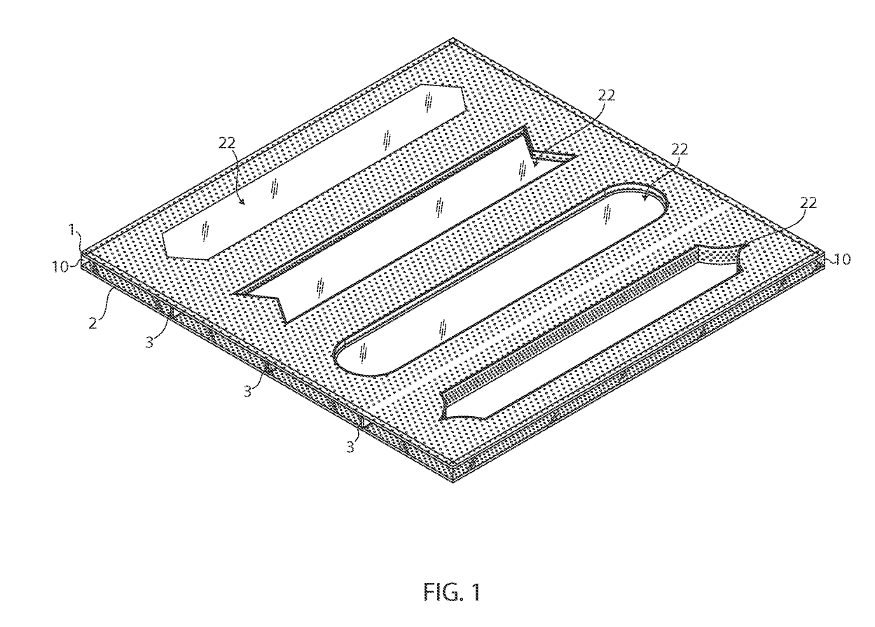

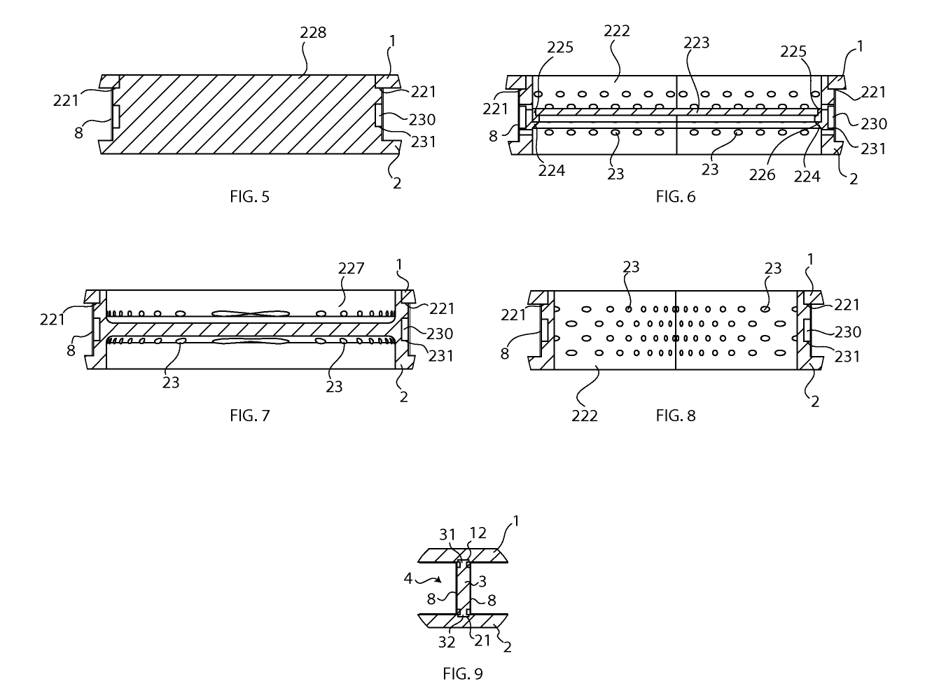

In reference to FIG. 1-4, the vessel base 2 is the foundation of the present invention. In the preferred embodiment of the present invention, the vessel base 2 comprises of a plurality of base partition slots 21, a plurality of view through components 22, and a plurality of base holes 23. The plurality of base holes 23 are small circular holes, slots, or oblong holes that traverse through the vessel base 2 and are evenly distributed about the entire surface of the vessel base 2. The plurality of base holes 23 reduces the amount of material used by the vessel base 2. By reducing the amount of material used by the vessel base 2, the vessel base 2 is less capable of direct conduction. With less direct conduction the overall insulating properties of the vessel base 2 is increased and less heat energy transfer occurs. The plurality of view through components 22 is upwardly protruding components on the vessel base 2 that provide a user with a clear area to view through the present invention. There are a number of different types of view through components 22. In reference to FIG. 5-8, the plurality of view through components 22 includes a hollow viewing component 222, an indented viewing component 227, and a solid viewing component 228. Each of the viewing components comprise of a cover view hole ledge 221. The cover view hole ledge 221 is a ledge that is peripherally positioned on the top surface of the plurality of view through components 22. The cover view hole ledge 221 allow the plurality of view through components 22 to engage the vessel cover 1 to ensure a sealed fit. Transparent adhesive may be applied at adjoining parts for additional sealing. The hollow viewing component 222 is a view through component having a hole, a dividing layer 223, a dividing layer ledge 224, a layer thermal break 225, and a layer seal adhesive 226. The dividing layer ledge 224 is a ledge that protrudes peripherally about the center of the hole. The dividing layer ledge 224 provides a rim in the hole where the dividing layer 223 is able to rest on. The layer thermal break 225 is a thermal breaking component that acts as a connecting adapter for the dividing layer 223 to the hole. The layer thermal break 225 is first adhered to the dividing layer ledge 224 and the hole by means of the layer seal adhesive 226. The dividing layer 223 is then secured within the hole by being adhered to the layer thermal break 225 by means if the layer seal adhesive 226. The layer seal adhesive 226 is able to hermetically seal the dividing layer 223 and the layer thermal break 225 to the hole. In the preferred embodiment of the present invention, the layer thermal break 225 is made from the material structural foam. The structural foam possesses a low thermal conductivity and can reduce the flow of thermal energy from the dividing layer 223 to the hollow viewing component 222 or vice versa. The insert can also be made with a hollow viewing component 222 that does not make use of the dividing layer 223, leaving the hole completely hollow, as shown in FIG. 8. The solid viewing component 228 is a solid protrusion that is completely clear throughout. The indented viewing component 227, similar to the solid viewing component 228, is a protrusion that is completely clear throughout. However, the indented viewing component 227 possesses a recessed space. The hollow viewing component 222 with a dividing layer 223 is similar to the indented viewing component 227. The difference is that the hollow viewing component 222 possesses a removable dividing layer 223 and the indented viewing component 227 possesses a permanent divider. When the present invention is exclusively using the hollow viewing component 222 with the dividing layer 223 or the indented viewing component 227 as an insulated glazing insert, the recessed space provided by the two different types of viewing components provides more space for the sealed glazing unit to fill more insulating gas. Each of the view through components 22 also comprises of a view through thermal break 230 and a view through side wall groove 231. The view through side wall groove 231 is a channel that is peripherally positioned and centered on each of the plurality of view through components 22. The view through thermal break 230 is inserted and secured inside the view through side wall groove 231 to provide additional thermal breaking To additionally secure the view through thermal break 230 in the view through side wall groove 231, a transparent adhesive can be applied before the view through thermal break 230 is inserted. In the preferred embodiment of the present invention, the view through thermal break 230 is made of structural foam. The plurality of view through side wall groove also comprises of a plurality of groove holes 232 that provide additional thermal breaking The plurality of base partition slots 21 is channels that are positioned on the face of the vessel between the view through components 22. The plurality of base partition slots 21 is used for an additional connection of the vessel base 2 to the vessel cover 1 for added support of and/or desired by the designer.

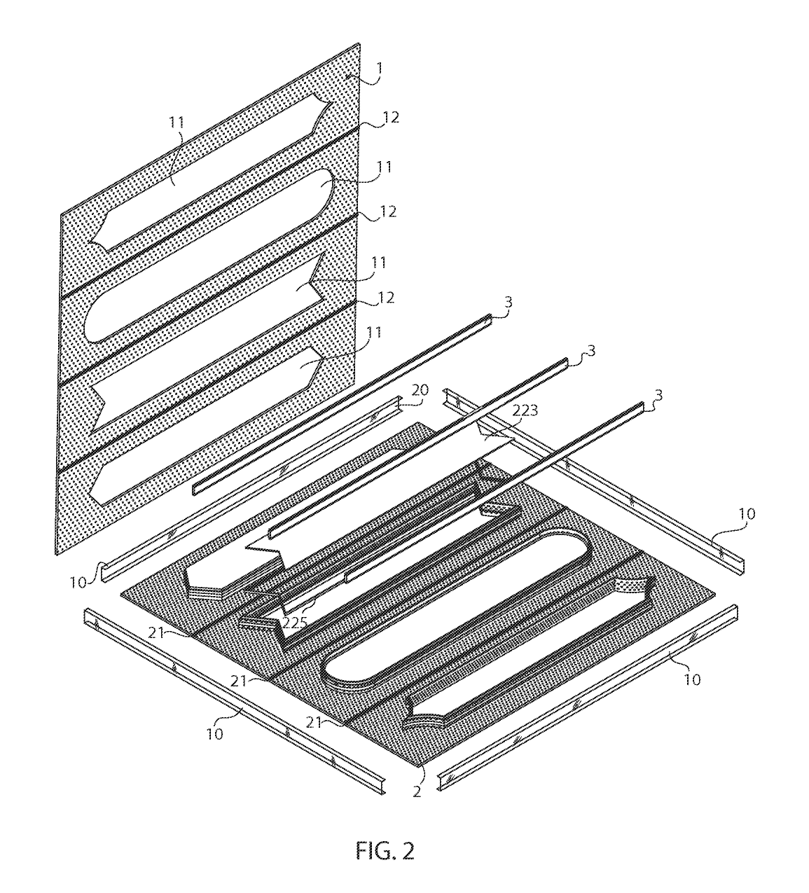

In reference to FIG. 2 and FIG. 4, the vessel cover 1 comprises of a plurality of cover viewing holes 11, a plurality of cover partition slots 12, and a plurality of cover holes 13. The plurality of cover viewing holes 11 is holes that traverse through the vessel cover 1. The plurality of cover viewing holes 11 is shaped consistently to the plurality of view through components 22. In addition, the plurality of cover viewing holes 11 is positioned on the vessel cover 1 in a manner that is aligned to the plurality of view through components 22. The plurality of cover view holes is used to be engaged to the plurality of view through components 22. The plurality of cover partitions slots is channels that are positioned on the face of the vessel cover 1 in between the cover viewing holes. The plurality of cover partitions slots is used for additional connection of the vessel cover 1 to the vessel base 2. Similar to the vessel base 2, the vessel cover 1 includes the plurality of cover holes 13 that are holes that traverse through and are evenly distributed about the entire surface. The plurality of cover holes 13 reduces the amount of material used by the vessel cover 1. By reducing the amount of material used by the vessel cover 1, the vessel cover 1 is less capable of direct conduction. With less direct conduction the overall insulating properties of the vessel cover 1 is increased and less heat energy transfer occurs.

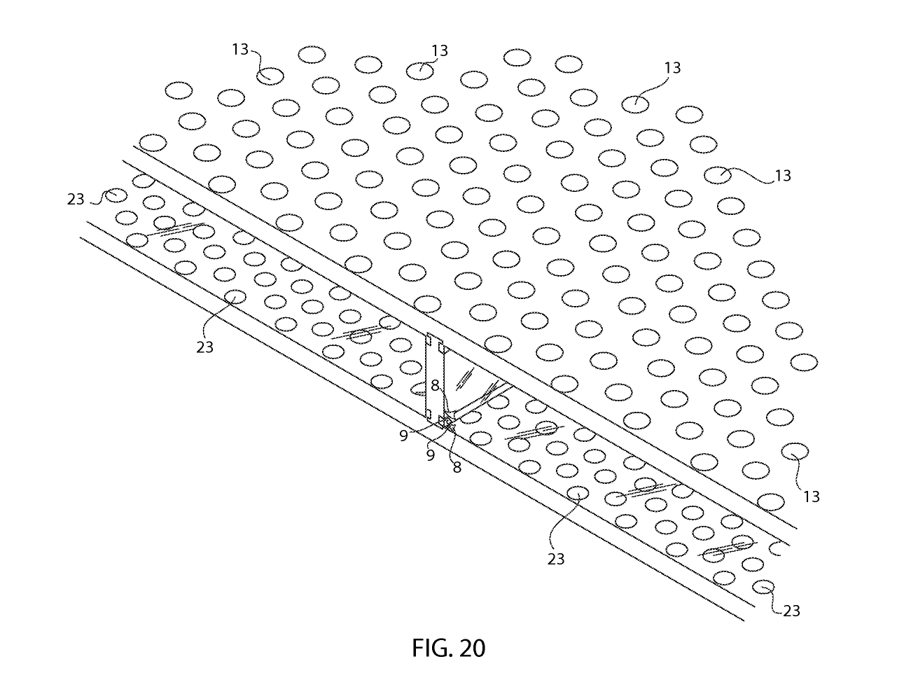

In reference to FIG. 2 and FIG. 4, the vessel base 2 is connected to the vessel cover 1 by means of the plurality of thermal break partitions 3. The plurality of thermal break partitions 3 comprises of a base connector 32 and a cover connector 31. The plurality of thermal breaking partitions is connected to the vessel base 2 by means of the base connector 32 being engaged to the plurality of base partition slots 21. Similarly, the plurality of thermal breaking partitions is connected to the vessel cover 1 by means of the cover connector 31 being engaged to the plurality of cover partition slots 12. In the preferred embodiment of the present invention, the plurality of thermal breaking partitions is made from the material structural foam. The plurality of thermal breaking partitions serves to thermally break the connection between the vessel base 2 and the vessel cover 1. To further ensure the connection of the vessel base 2 and the vessel cover 1, the cover view holes ledges of the plurality of view through components 22 are aligned and engaged to the plurality of cover viewing holes 11. With the vessel base 2 and the vessel cover 1 connected, the plurality of cavities 4 is defined. The plurality of cavities 4 is the space defined by the vessel cover 1, the vessel base 2, and the plurality of thermal break partitions 3. The plurality of thermal break partitions 3 act as the walls separating the each of the plurality of cavities 4. The plurality of end openings 5 is the openings defined by the side edges of the vessel base 2 and the vessel cover 1 leading into the plurality of cavities 4. The plurality of cavities 4 are filled by the insulating element 6 to provide the present invention with further insulating properties. The insulating element 6 can be Nanogel particles, Aerogel particles, Maerogel particles or other suitable gel technologies that may, in the future be approved upon. All these types of gels are excellent insulators trapping air. These gels are generally a large percentage of air and a very small percentage of actual solid. The large amount of air that this material traps is what makes it a strong insulator. However, these gels are not transparent, but rather translucent. Therefore, although not allowing users to see through the insulating insert, it will still allow light to traverse through it. The preferred material for the insulating element 6 is the translucent Cabot Nanogel translucent daylighting particles due to its abilities to allow the desired amount of light through. The second preferred material for the insulating element 6 is Aerogel and the third is Maerogel. In the preferred embodiment of the present invention, the internal walls of the plurality of cavities 4 are laminated with the interior vessel film 8 by means of the film adhesive 9, as shown in FIG. 20. The plurality of cavities 4 is laminated with the interior vessel film 8 to seal the plurality of cover holes 13 and the plurality of base holes 23 ensuring the insulating element 6 is completely sealed with in the present invention. In addition, the plurality of end openings 5 is sealed by the end opening sealing film 10 by means of the sealing adhesive 20. The end opening sealing film 10 prevents the insulating element 6 from leaking or falling out of the plurality of cavities 4 from the plurality of end openings 5. In addition to its purpose of sealing the plurality of cover holes 13 and the plurality of base holes 23, the interior vessel film 8 helps manage light through the insulating insert. The interior vessel film 8 is preferred to be made of Biaxially-oriented polyethylene terephthalate film. However, the interior vessel film 8 can optionally be made from reflective film, sputtered film, polyester film, ceramic film, or tinted film, depending on the environment and the effect the user wishes the present invention to have. The interior vessel film 8 may be optically clear, translucent or both. The interior vessel film 8 may be used to reflect or manage radiant heat and further enhances the insulating properties of the present invention. The Biaxially-oriented polyethelene terephthalene film can also be used to reflect and disperse light into a building. In the preferred embodiment of the present invention, the plurality of cavities 4 is sized so that the walls of the vessel base 2, the vessel cover 1, the plurality of thermal break partitions 3, and the plurality of view through components 22 are 2 mm thick. Thicker polycarbonate may be used to add strength. However, by having thinner solid polycarbonate walls, there is less solid heat conducting material in which heat can be transferred through the present invention.

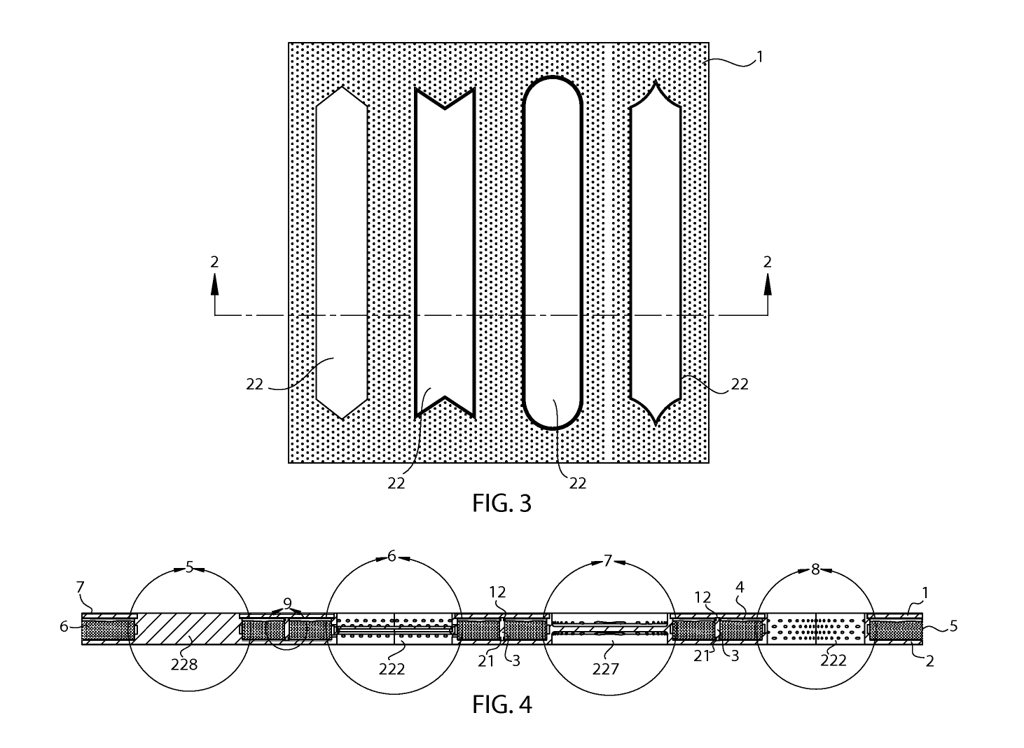

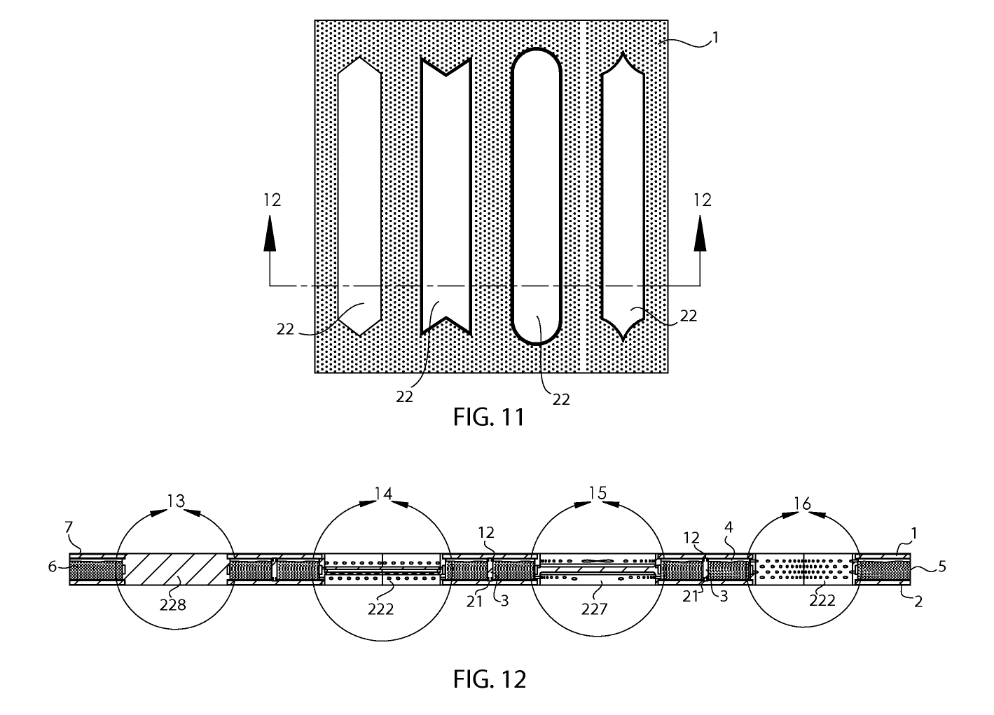

In reference to FIG. 3 and FIG. 11, the plurality of viewing components can by manufactured into any shape or size. As the majority of the area of the present invention is obscured by the insulating element 6, the shape and size of the plurality of view through components 22 determine the area in which the user is able to view through the present invention. In addition to the shape and size of the plurality of view through components 22, the side walls of the plurality of view through components 22 can be angled. Providing angled view through components 22 allows user to have a wider range of view through the present invention as well as allow more natural light to enter at any time during the day. The additional light that is allowed through by the angled view through components 22 also reduces any shadowing that may be caused by the present invention. With additional light entering, there is less need for users to use artificial lighting and as a result they will be able to lower their energy bills for lighting. The present invention can be customized with varying angles for the plurality of view through components 22 to fit the environment and situation that the user is under. The angling of the view through components 22 also offer more security for the user as it allows user to see out the present invention more easily while making it difficult for outsiders to see into a room using the present invention.

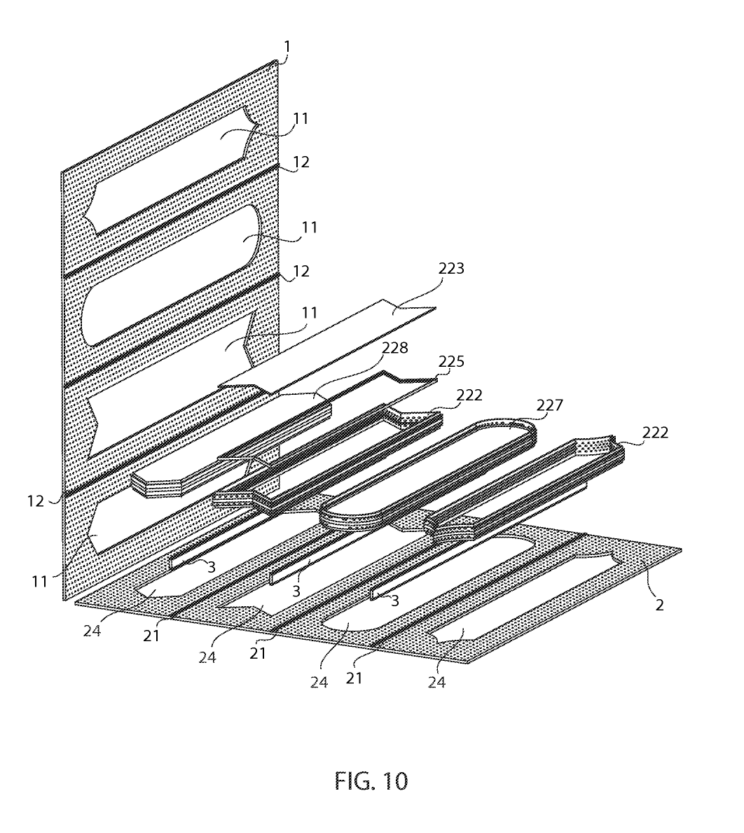

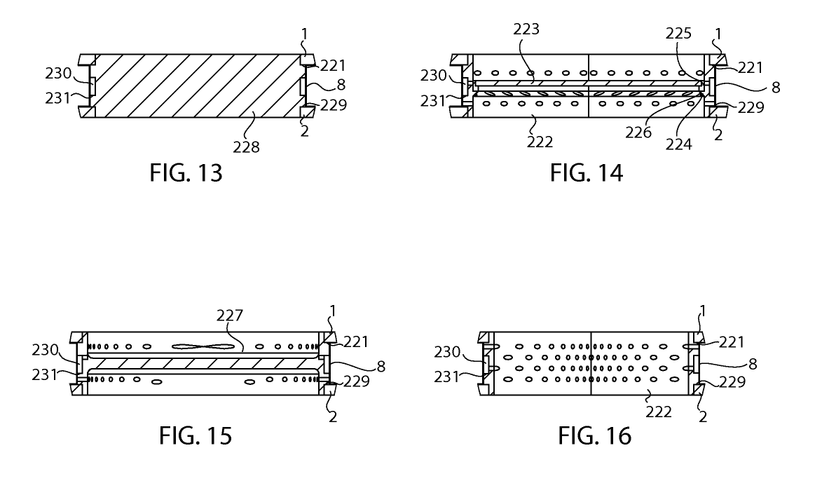

In reference to FIG. 10-16, in another embodiment of the present invention, the plurality of view through components 22 is not fully integrated with the vessel base 2, but is separated. In this embodiment of the present invention, the vessel base 2 and the vessel cover 1 are identically shaped, but mirror one another to ensure corresponding connections. In this embodiment of the present invention, the vessels cover still comprises of a plurality of cover viewing holes 11, a plurality of cover partitions slots, and a plurality of cover holes 13. The vessel base 2 comprises, being similar with the vessel cover 1, comprises of a plurality of base viewing holes, a plurality of base partitions slots, and a plurality of base holes 23. The view through components 22 now additionally comprises of a base view hole ledge 229 which allows it to engage to the vessel base 2. The plurality of view through components 22 are engaged to the vessel base 2 by means of the base view hole ledge 229 being aligned and engaged to the plurality of base viewing holes. The plurality of view through components 22 are still engaged to the vessel cover 1 by means of the cover view hole ledge 221 being aligned and engaged to the plurality of cover viewing holes 11.

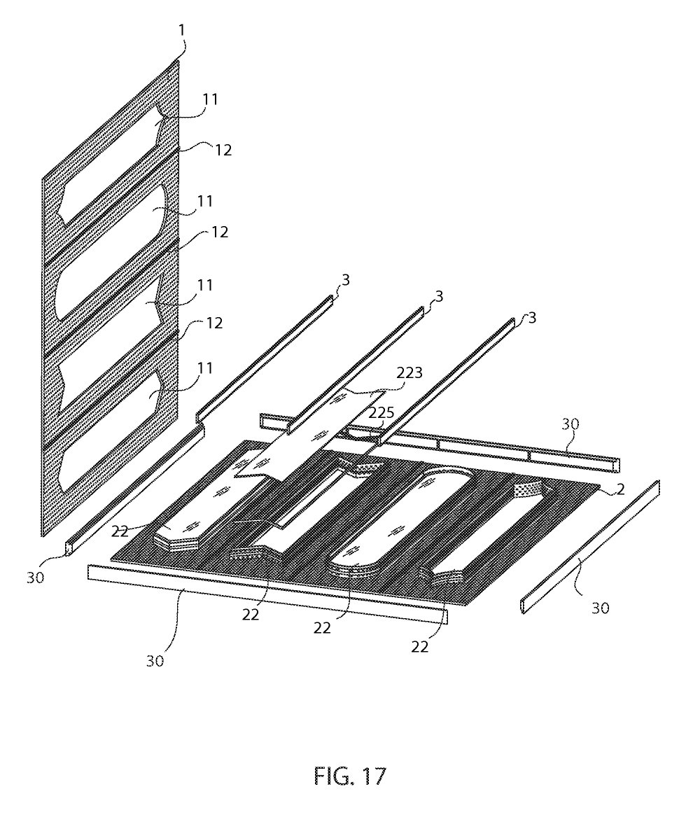

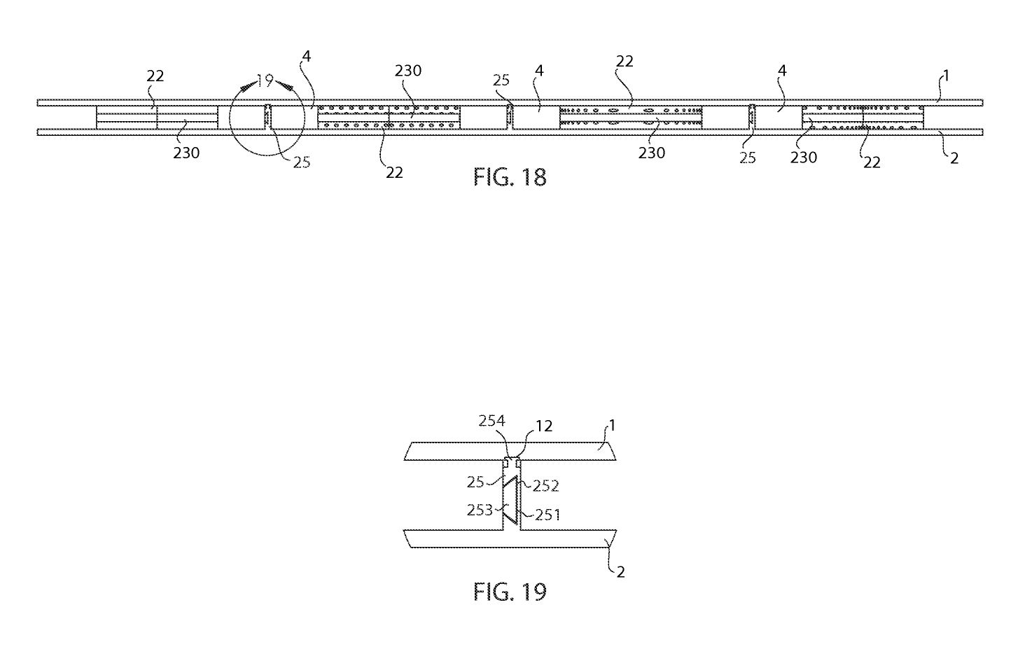

In reference to FIG. 18-19, in another embodiment of the present invention, the insert does not comprise of the plurality of thermal break partitions 3. Instead, the vessel base 2 comprises of a plurality of partitions 25 that are fully integrated with the vessel base 2. In addition, the plurality of end openings 5 are not sealed by means of the end opening sealing film 10, but are sealed by a plurality of end caps 30. In this embodiment of the present invention the vessel cover 1 comprises of the plurality of cover viewing holes 11, the plurality of cover partition slots 12, and the plurality of cover holes 13. In this embodiment of the present invention, the plurality of view through components 22 is fully integrated with the vessel base 2. However, in other embodiments of the present invention, the plurality of view through components 22 can be separate from the vessel base 2. The vessel base 2 comprises of the plurality of partitions 25, the plurality of view through components 22, and the plurality of base holes 23. Unlike the plurality of thermal break partitions 3, the plurality of partitions 25 is fully integrated with the vessel base 2. The fully integrated plurality of partitions 25 is made of a material consistent to the vessel base 2. To provide the plurality of partitions 25 thermal breaks, the plurality of partitions 25 further comprises of a notch groove 251, a thermal break component 253, and a cover notch 254. The plurality of partitions 25 is upwardly protruding walls on the vessel base 2 that are positioned between the view through components 22. For this embodiment of the present invention, the vessel cover 1 is attached to the vessel base 2 by means of the connection of the plurality of cover partition slots 12 being engaged to the cover notch 254 of the plurality of partitions 25. The cover notch 254 is a protrusion along the top surface of the plurality of partitions 25 that correspond to the shape of the plurality of cover partitions slots. The notch groove 251 and the thermal break component 253 allow the plurality of partitions 25 to be thermally broken. The notch groove 251 is an open channel that traverses through a side of the plurality of partitions 25 lengthwise. The thermal break component 253 is inserted and secured into the notch groove 251 by a transparent adhesive. The thermal break component 253 is shaped to conform to the shape of the notch groove 251. The notch groove 251 and the thermal break component 253 reduce the amount of polycarbonate that is used by the vessel base 2 to increase the present invention's insulating properties. In this embodiment of the present invention, the plurality of end openings 5 is sealed by the plurality of end caps 30, like the embodiment shown in FIG. 17. The plurality of end caps 30 is made from structural foam and shaped to seal the plurality of end openings 5. The plurality of end caps 30 is engaged to and adhered to the plurality of end openings 5 by the sealing adhesive 20. The plurality of end caps 30 is shaped to have a flush fit with all the side edges of the present invention. Although structural foam is preferred for the thermal break component 253 and the plurality of end caps 30 that the glazing is inserted into other suitable flexible and strong aerogels (not brittle and friable) may be used. These include suitable emerging technologies that are adequately enhanced having mechanically adequate properties by means of vapor-phase cross-linking, liquid-phase cross-linking, reduced bonding and fiber reinforcing. Included is silica x-aerogels exhibiting rubber-like flexibility. Polymers can also be used to crosslink aerogels such as epoxides, polyisocyanates and polystyrene rendering certain emerging technologies suitable while having low thermal conductivity. To further contribute to the thermal breaking in the notch groove 251, the notch groove 251 is coated with a layer of thermal breaking coating 252 before the thermal breaking structural foam is inserted and secured. It is preferred that the thermal breaking coating 252 be Nansulate coating to create the thermal break.

The plurality cover holes and the plurality of base holes 23 that are evenly distributed on all the surfaces of the insulating insert serve to reduce the amount of solid polycarbonate surfaces that can directly conduct heat energy. The edges of the view through components 22 can also be manufactured according to a user's environment and preferences. For example, the sun is higher, hotter and has more damaging UV during the summer and will provide more light, heat and UV than desired, so the edges can be angled to manage the sun's rays and, or, light. However, with a lower sun during the winter and a lower sun later in the day during the summer, so the angles of the edges may be made to allow the optimal amount of light in while insulating. Many different possible geometric shapes can exist for the present invention.

The system can be having different configurations to effectively manage the sun's rays and, or, light. This can be done by specifying angles for the view through components 22 edges. The types of configuration used can effectively minimize three types of heat transfers including radiation, conduction, and convection. The gel insulating element 6 sealed within the vessels are excellent insulators which can reduce radiant heat as well as any conduction of heat. When used with a sealed insulating glazing unit with the use of argon gas within the sealed unit, due to the gas' heavier and thicker properties, convection is limited through the unit as well. The present invention serving as a window insert, can provide a double pane insulated glazing unit (IGU) with the properties of a triple pane IGU. By inserting the present invention into the sealed cavity of an IGU, the present invention is able to bisect the space inside the IGU. The bisection of the sealed space creates two separate spaces. The division of the sealed space significantly reduce energy transfer that would, although be reduced by the gas, still exist due to convection. Convection is well established as the transmission of heat through the current circulation of air or gas inside the IGU cavity. Such current circulation includes vertical movement of heat, especially by updrafts and downdrafts in an IGU cavity between the two layers of glazing. The thermal break components 253 in the present invention are used in the present invention that separates the multiple components that are in direct connection. Without the thermal breaking components, direct conduction would undermine the invention's ability to even further minimize heat transfer. The thermal breaking components serves to reduce heat transfer and increase overall thermal performance. The thermal break is constructed of a less-conductive material such as structural foam or other suitable low conductive material or other suitable technologies that may in the future be made available. The top and bottom sides of the vessel view through components 22 will have a steeper angle as to block solar heat and light when the sun is high and hot with maximum UV. For users in colder climates, a configuration of the system may include clear areas for more light to enter. Edges can be angled to allow much larger field of view out the system. Also a vessel filled with suitable gel insulation will insulate to keep heat inside of building.

Some factors that can help users determine what configuration of the present invention they would like include the following:
1. Elevation and if there is any type of natural or artificial obstacle that can block the sun such as another building or a mountain.
2. Solar patterns averaged year round.
3. Geographical positions of the building and surfaces.
4. Average year round temperature.
5. Year round cloud coverage.
6. Direction in which the window is facing.
7. Use of the building. (Museums or offices)
8. Average hours of daylight annually and desired light.
9. Effect desired from glazing.
10. User's tolerance of shadowing.
11. User's preference of tinting or coloring.
12. Curvature or angling of windows (if any).
13. Use of vessels to block visibility when desired.
14. Amount of glare the user is trying to block.
15. Aftermarket window films to be later applied.
16. Amount of privacy desired by user.
17. Distance desired by user to be able to see out of the system.
18. Range of unobstructed vision desired by user looking (up, down, left, right).
19. Amount of polycarbonate desired for added security from outsiders breaking in.
20. Amount of polycarbonate desired for added strength to prevent breakage.
21. The direction in which viewers will be permitted to see through.

This system allows for users to see through the present invention while being efficient in minimizing the heat transfer across the window. All of the components of the present invention contribute in excellent insulating properties by reducing solar heat gain and significantly reducing transmittance of the destructive ultraviolet rays. The areas on the system which are covered by suitable gel insulation in combination with the gas sealed within an IGU together enhance the insulation for stopping heat transfer from any conduction through a window. This will help leakage of heat from the building during the winters as well as prevent heat from entering building during the summers. The films used in the present invention help manage the harmful rays such as UV that are projected from the sun to protect the users and objects within a room from damage. Any number of different shapes and sizes can be used for the present invention for different designs. The gel insulated vessel areas between arrangements of view through components 22 allow users to see through the optically clear glazing panes of an IGU. In addition, the angled edges of the view through component can allow users to have a larger field of vision while also limiting the heat transferring through.

The ability of this system to control the direction that viewers can see through the system inside and outside make this system a corrective lens as shown in FIG. 21. A lens system is defined by a transparent optical device used to converge or disperse transmitted light to form images. Due to the ability of the present invention to diverge light into a room, the invention is a type of lens system. By controlling the angling of the edges of the view through components 22 of the insert system can collectively manipulate a user's range and direction of vision. With control of a viewer's vision through the system, the present invention can also improve security of a building by limiting a viewer's ability to see into a building. For example, a window may extend the entire height from a floor to a ceiling, exposing an entire room or office to the outside. A vessel can be customized to completely cover the bottom portion of the window to block an outsider from viewing the clutter inside an office. However, it can also be short enough to allow a viewer from the inside to stand up to see out the window. There may also be instances where the view outside a window is desired to be limited or eliminated. By controlling the angles of the view through components 22, viewers can only be allowed to see through a window at a limited angle. This may be desired if a view out a window may include areas which are not pleasant to view. For example, an office may be facing a view with the ocean to the left and a junkyard to the right, users of the window system may customize the view through components 22 to be angled to block the view to the right while permitting views to the left.

Although the invention has been explained in relation to its preferred embodiment, it is to be understood that many other possible modifications and variations can be made without departing from the spirit and scope of the invention as hereinafter claimed

What is claimed is:

1. An insulating corrective lens insert for window comprises,
a vessel cover;
a vessel base;
a plurality of thermal break partitions;
a plurality of end openings;
an insulating element;
a vessel coating;
an interior vessel film;
a film adhesive;
an end opening sealing film;
a sealing adhesive;
a plurality of cavities;
the vessel cover comprises of a plurality of cover viewing holes, a plurality of cover partition slots, and a plurality of cover holes;
the vessel base comprises a plurality of view through components, a plurality of base partitions slots, and a plurality of base holes.
the plurality of thermal break partitions comprises a cover connector and a base connector; and
the plurality of view through components comprises a hollow viewing component, an indented viewing component, and a solid viewing component, wherein each viewing component further comprises a cover view hole ledge.

2. The insulating corrective lens insert for window as claimed in claim 1 comprises,
the plurality of cover viewing holes being holes traversing through the vessel cover;
the plurality of cover partition slots being a channel positioned on a face of the vessel cover between the cover view holes; and
the plurality of cover holes being small circular holes distributed evenly throughout the face of the vessel cover traversing through the vessel cover.

3. The insulating corrective lens insert for window as claimed in claim 2 comprises,
wherein the plurality of cover viewing holes is shaped consistent to and positioned to align to the plurality of view through components.

4. The insulating corrective lens insert for window as claimed in claim 1 comprises,
the plurality of base holes being small circular holes distributed evenly throughout and traversing through the vessel base;
the plurality of view through components being upwardly protruding on the vessel base within the plurality of cavities; and
the plurality of base partition slots being a channel positioned on the face of the vessel between the view through components.

5. The insulating corrective lens insert for window as claimed in claim 4 comprises,
the plurality of view through components having a view through side wall groove and a view through thermal break, wherein the plurality of view through components have angled side walls to direct vision;
the view through side wall groove being a channel peripherally positioned about the plurality of view through components;
the plurality of view through thermal breaks being secured inside the view through side wall groove;
the hollow viewing component having a hole, a dividing layer, a dividing layer ledge, a layer thermal break, and a layer seal adhesive;
the dividing layer ledge being protruded peripherally about the hole;
the layer thermal break being adhered to the dividing layer ledge and the hole by the layer seal adhesive; and
the dividing layer being secured within the hole by being adhered to the layer thermal break by the layer seal adhesive.

6. The insulating corrective lens insert for window as claimed in claim 1 comprises,
the vessel base being connected to the vessel cover by means of the plurality of thermal break partitions;
the plurality of thermal break partitions being connected to the vessel base by means of the base connector being engaged to the plurality of base partition slots;
the plurality of thermal break partitions being connected to the vessel cover by means of the cover connector being engaged to the plurality of cover partition slots;
the plurality of cavities being a space defined by the vessel base, the vessel cover, and the plurality of thermal break partitions; and
the cover view hole ledge being aligned and engaged to the plurality of cover viewing holes.

7. The insulating corrective lens insert for window as claimed in claim 6 comprises,
the plurality of end openings being an opening defined by the vessel base and the vessel cover leading into the plurality of cavities;
the plurality of cavities being filled by the insulating element;
the vessel cover and the vessel base being coated by the vessel coating;
the plurality of cavities being laminated by the interior vessel film by means of the film adhesive, wherein the lamination of the plurality of cavities seals the plurality of cover holes and the plurality of base holes; and
the plurality of end openings being sealed by the end opening sealing film by means of the sealing adhesive.

8. An insulating corrective lens insert for window comprises,
a vessel cover;
a vessel base;
a plurality of thermal break partitions;
a plurality of end openings;
an insulating element;
a vessel coating;
an interior vessel film;
a film adhesive;
an end opening sealing film;
a sealing adhesive;
a plurality of cavities;
a plurality of view through components
the vessel cover comprises of a plurality of cover viewing holes, a plurality of cover partition slots, and a plurality of cover holes;
the vessel base comprises a plurality of base partition slots, a plurality of base viewing holes, and a plurality of base holes;
the plurality of thermal break partitions comprises a cover connector and a base connector; and
the plurality of view through components comprises a hollow viewing component, an indented viewing component, and a solid viewing component, wherein each viewing component further comprises a cover view hole ledge and a base view hole ledge.

9. The insulating corrective lens insert for window as claimed in claim 8 comprises,
the plurality of cover viewing holes being holes traversing through the vessel cover;
the plurality of cover partition slots being a channel positioned on a face of the vessel cover between the cover view holes; and
the plurality of cover holes being small circular holes distributed evenly throughout the face of the vessel cover traversing through the vessel cover.

10. The insulating corrective lens insert for window as claimed in claim 8 comprises,
the plurality of base viewing holes being holes traversing through the vessel base;
the plurality of base holes being small circular holes distributed evenly throughout and traversing through the vessel base; and
the plurality of base partition slots being a channel positioned on the face of the vessel between the view through components.

11. The insulating corrective lens insert for window as claimed in claim 10 comprises,
the plurality of view through components having a view through side wall groove and a view through thermal break, wherein the plurality of view through components have angled side walls to direct vision;
the view through side wall groove being a channel peripherally positioned about the plurality of view through components;
the view through side wall groove having a plurality of groove holes evenly distributed;
the plurality of view through thermal breaks being secured inside the view through side wall groove;
the hollow viewing component having a hole, a dividing layer, a dividing layer ledge, a layer thermal break, and a layer seal adhesive;
the dividing layer ledge being protruded peripherally about the hole;
the layer thermal breaking being adhered to the dividing layer ledge and the hole by the layer seal adhesive; and
the dividing layer being secured within the hole by being adhered to the layer thermal break by the layer seal adhesive.

12. The insulating corrective lens insert for window as claimed in claim 8 comprises,
the vessel base being connected to the vessel cover by means of the plurality of thermal break partitions;
the plurality of thermal break partitions being connected to the vessel base by means of the base connector being engaged to the plurality of base partition slots;
the plurality of thermal break partitions being connected to the vessel cover by means of the cover connector being engaged to the plurality of cover partition slots;
the plurality of cavities being a space defined by the vessel base, the vessel cover, and the plurality of thermal break partitions;
the cover view hole ledge being aligned and engaged to the plurality of cover viewing holes; and
the base view hole ledge being aligned and engaged to the plurality of base viewing holes.

13. The insulating corrective lens insert for window as claimed in claim 12 comprises,
the plurality of end openings being an opening defined by the vessel base and the vessel cover leading into the plurality of cavities;
the plurality of cavities being filled by the insulating element;
the vessel cover and the vessel base being coated by the vessel coating;
the plurality of cavities being laminated by the interior vessel film by means of the film adhesive, wherein the lamination of the plurality of cavities seals the plurality of cover holes and the plurality of base holes; and
the plurality of end openings being sealed by the end opening sealing film by means of the sealing adhesive.

14. An insulating corrective lens insert for window comprises,
a vessel cover;
a vessel base;
a plurality of end openings;
an insulating element;
a vessel coating;
an interior vessel film;
a film adhesive;
a plurality of end caps;
a sealing adhesive;
a plurality of cavities;
the vessel cover comprises of a plurality of cover viewing holes, a plurality of cover partition slots, and a plurality of cover holes;
the vessel base comprises a plurality of partitions, a plurality of view through components, a and a plurality of base holes.
the plurality of partitions comprises a notch groove, a thermal break component, and a cover notch; and
the plurality of view through components comprises a hollow viewing component, an indented viewing component, and a solid viewing component, wherein each viewing component further comprises a cover view hole ledge.

15. The insulating corrective lens insert for window as claimed in claim 14 comprises,
the plurality of cover viewing holes being holes traversing through the vessel cover;
the plurality of cover partition slots being a channel positioned on a face of the vessel cover between the cover view holes; and
the plurality of cover holes being small circular holes distributed evenly throughout the face of the vessel cover traversing through the vessel cover.

16. The insulating corrective lens insert for window as claimed in claim 14 comprises,
the plurality of base holes being small circular holes distributed evenly throughout and traversing through the vessel base;
the plurality of view through components being upwardly protruding on the vessel base within the plurality of cavities; and
the plurality of partitions being upwardly protruding on the vessel base between the view through components.

17. The insulating corrective lens insert for window as claimed in claim 16 comprises,
the notch groove being an open channel positioned on the plurality of partitions; and
the thermal break component being inserted and secured into the notch groove.

18. The insulating corrective lens insert for window as claimed in claim 14 comprises,
the plurality of view through components having a view through side wall groove and a view through thermal break, wherein the plurality of view through components have angled side walls to direct vision;
the view through side wall groove being a channel peripherally positioned about the plurality of view through components;
the view through side wall groove having a plurality of groove holes evenly distributed;
the plurality of view through thermal breaks being secured inside the view through side wall groove;
the hollow viewing component having a hole, a dividing layer, a dividing layer ledge, a layer thermal break, and a layer seal adhesive;
the dividing layer ledge being protruded peripherally about the hole;
the layer thermal breaking being adhered to the dividing layer ledge and the hole by the layer seal adhesive; and
the dividing layer being secured within the hole by being adhered to the layer thermal break by the layer seal adhesive.

19. The insulating corrective lens insert for window as claimed in claim 14 comprises,
the vessel cover being connected to the vessel base by means of the cover partition slot being engaged to the cover notch;
the plurality of cavities being a space defined by the vessel base, the vessel cover, and the plurality of partitions; and
the cover view hole ledge being aligned and engaged to the plurality of cover viewing holes.

20. The insulating corrective lens insert for window as claimed in claim 19 comprises,
the plurality of end openings being an opening defined by the vessel base and the vessel cover leading into the plurality of cavities;
the plurality of cavities being filled by the insulating element;
the vessel cover and the vessel base being coated by the vessel coating;
the plurality of cavities being laminated by the interior vessel film by means of the film adhesive, wherein the lamination of the plurality of cavities seals the plurality of cover holes and the plurality of base holes;
the plurality of end caps being engaged and adhered to the plurality of end openings by the sealing adhesive; and
the plurality of end openings being sealed by the plurality of end caps.
